(19) United States
(12) Patent Application Publication
(10) Pub. No.: US 2010/0065475 A1
(43) Pub. Date: Mar. 18, 2010

(54) PROCESS FOR FCC PRETREATMENT BY MILD HYDROCRACKING INCLUDING DILUTING THE FEEDSTOCK WITH A FEEDSTOCK OF BIOLOGICAL ORIGIN

(75) Inventors: Christophe Gueret, LE HAVRE (FR); Vincent Mayeur, Notre Dame De Gravenchon (FR)

Correspondence Address: SUGHRUE MION, PLLC, 2100 PENNSYLVANIA AVENUE, N.W., SUITE 800, WASHINGTON, DC, 20037, US

(73) Assignee: TOTAL RAFFINAGE MARKETING, PUTEAUX (FR)

(21) Appl. No.: 12/558,968

(22) Filed: Sep. 14, 2009

(30) Foreign Application Priority Data
Sep. 15, 2008 (FR) 08 05036

(51) Int. Cl. C10G 69/04; B01J 8/18

(52) U.S. Cl. 208/61; 422/139

(57) ABSTRACT

Process for FCC pretreatment by mild hydrocracking including diluting the feedstock with a feedstock of biological origin The invention relates to a process which comprises the stages consisting in carrying out a mild hydrocracking, implemented under a pressure of 20 to 120 bar and at a temperature of between 300 and 500° C., on a hydrocarbon feedstock comprising or consisting of a feedstock of petroleum origin, comprising or consisting of a vacuum distillate fraction and/or a deasphalted oil, at least 85% by weight of which boils above 370° C., and a feedstock of biological origin comprising components of vegetable oil and/or animal fat type, in order to produce gas oil and an effluent having an initial boiling point of greater than 330° C. within the meaning of the simulated distillation according to standard ASTM D2287, and carrying out a catalytic cracking (FCC) of a composition comprising or consisting of said effluent, and to a plant which makes it possible to carry out this process.

The present invention comes within the technical field of the cracking of hydrocarbon feedstocks. More particularly, the invention relates to a process in which a vacuum distillate fraction and/or a deasphalted oil is/are diluted with a fraction of biological origin of the vegetable oil and/or animal fat type, before it is treated by mild hydrocracking, this mild hydrocracking stage being prior to the treatment by FCC (Fluid Catalytic Cracking).

Mild hydrocracking proves to be a particularly advantageous application in the pretreatment of FCC. This is because it is well known that, when a mild hydrocracking is carried out upstream of the FCC, the sulfur content in FCC gasolines and NOₓ and SOₓ emissions are significantly reduced.

The reduction in the sulfur content of FCC gasolines is essential since they constitute a large part of the gasoline pool of a refinery. Furthermore, the change towards stricter standards regarding the quality of fuels is forcing a move towards innovative schemes which make it possible, inter alia, to achieve sulfur contents of less than 10 ppm in gasolines and in gas oils (in particular in specifications for the European Union). Apart from the sulfur content, it is also important and advantageous to reduce the contents of nitrogen, of aromatics and of polyaromatics.

Various hydrodesulfurization processes are well known and mild hydrocracking is applied to the treatment of feedstocks of vacuum distillate (VD in abbreviated form) or VGO (Vacuum Gas Oil) type and also to deasphalted oils (DAO). These feedstocks comprise high contents of sulfur and of nitrogenous compounds.

However, these processes of the prior art generally result in a gas oil fraction having an entirely fossil origin. In point of fact, for the purpose both of reducing emissions of greenhouse gases and in order to be in accordance with standards and/or directives relating to the environment, it is desirable to use compounds of biological origin, in particular of agricultural origin, in fuels.

For example, European Directive 2003/30/EC is targeted in particular at promoting the use of biofuels. In transportation, the European Community has adopted an objective of a portion of biofuels of 5.75% of the NCV (Net Colorific Value) of fuels in 2010, that is to say that the amount of biofuel present in the mixture should provide 5.75% of the NCV of the mixture.

Currently, the French government has imposed a tax: the TGAP (Taxe Générale des Activités Polluantes) [General Tax on Polluting Activities], which relates to fuels consumed on French soil. The fuels subject to this tax are “SP95” [regular unleaded gasoline], “SP98” [super unleaded gasoline] and “Gazole Moteur” [automotive gas oil]. The object of this tax is to prompt the incorporation of biofuel of agricultural origin, the %NCV (Net Calorific Value) being gradually increased from 1.75% in 2006 to 7.00% in 2010.

This addition is carried out on the energy base and the “Bio” origin of the products incorporated. Thus, ETBE (ethyl tert-butyl ether) is experiencing a reduction in its level since it comprises only 47% by weight of ethanol of agricultural origin and a lower NCV than gasoline.

For automotive gas oils, the most commonly used biofuels are vegetable oil esters, such as the methyl ester of rapeseed oil (RME).

These automotive gas oils are generally obtained by mixing the biofuel with the automotive gas oil after treatment of the latter. These mixtures are thus often produced by the distributors, immediately before the distribution of the fuel.

The mixtures obtained from vegetable oil methyl esters exhibit the advantage of a cetane number in accordance with the standard but their density is much greater than the specification of the standard (greater than 800 kg/m³), which results in difficulties in formulation at high levels of incorporation.

Processes for refining biomass, which have been developed in order to produce biofuels, are already known. Thus, the documents U.S. Pat. No. 4,992,605, U.S. Pat. No. 5,705,722 and SE 520 633 describe processes for the hydrotreating of the triglycerides forming the vegetable oils.

Processes for hydrocracking vegetable oils which make it possible to obtain gas oils are also known. Thus, the documents FR 2 607 803 and U.S. Pat. No. 5,233,109 describe processes for the hydrocracking of the triglycerides forming the vegetable oils.

Processes for the hydrotreating of a feedstock of petroleum origin of gas oil type mixed with a feedstock of vegetable oils and/or of animal fats are also known. For example, the document EP 1 693 432 describes a process for the hydrotreating of a feedstock of petroleum origin mixed with vegetable oil.

However, the processes described in the prior art may be expensive, may be insufficiently effective, for example in terms of yield, and/or may exhibit a low ecological balance, in particular with regard to energy consumption.

The processes of the prior art generally envisage dedicated plants, which implies a low flexibility in the use of these plants. This is because the processes for the hydrotreating and hydrocracking of pure vegetable oils require the construction of specific units and the products have to be subsequently mixed with the gas oils or gasolines obtained by refining petroleum products.

Very particularly, the processes of the prior art exhibit a problem related to the deactivation of the catalyst, in particular by products obtained from the feedstock of biological origin, such as carbon monoxide.

An aim of the present invention is thus to overcome, in all or in part, the disadvantages mentioned above.

To this end, the invention describes a process, which comprises the stages consisting in:

carrying out a mild hydrocracking, implemented under a pressure of 20 to 120 bar and at a temperature of between 300 and 500° C., on a hydrocarbon feedstock comprising or consisting of:

a feedstock of petroleum origin, comprising or consisting of a vacuum distillate fraction and/or a deasphalted oil, at least 85% by weight of which boils above 370° C., and

a feedstock of biological origin comprising components of the vegetable oil and/or animal fat type,

in order to produce gas oil and an effluent having an initial boiling point of greater than 330° C. within the meaning of the simulated distillation according to standard ASTM D2887, and

carrying out a catalytic cracking (FCC) of a composition comprising or consisting of said effluent.

The vacuum distillate fraction can be a vacuum distillate resulting from the direct distillation of the crude or from a conversion process, such as coking, visbreaking or FCC, or also any mixture of the effluents from the abovementioned processes.

The deasphalted oil can originate from a deasphalting unit. Generally, the residue from the vacuum distillation (vacuum residue) is deasphalted and said deasphalted residue constitutes the deasphalted oil.

The vacuum distillate fraction and/or the deasphalted oil can participate in the composition of the feedstock of petrolum origin for which at least 85% by weight exhibits a boiling point of greater than 370° C. within the meaning of the ASTM D2887 simulated distillation.

This is because the Applicant Company has found, surprisingly, that the feedstock of biological origin undergoes a hydrotreating but that virtually none of the n-paraffins thus formed undergo hydrocracking. These n-paraffins are thus reencountered in the liquid products and very predominantly in the gas oil fraction obtained. This is because the triglycerides of the feedstock of biological origin are completely decomposed to give paraffins belonging to the distillation range of gas oils.

Furthermore, it has been found that the amounts of CO and CO₂ formed are low, in comparison with the amounts formed in a process for the hydrotreating of petroleum fractions of gas oil type as a mixture with fractions of biological origin of the vegetable oil and/or animal fat type. Specifically, the decarboxylation/decarbonylation of the fatty acid molecules present in the triglycerides bring about the emission of CO or CO₂ gas, reducing the hydrogen partial pressure. Furthermore, in addition to the problems of safety with regard to personnel, CO is a reversible inhibitor of the desulfurization activity of the hydrotreating and hydrocracking catalyst. In point of fact, the use of the process according to the invention results in only a slight formation of the gases CO and CO₂, so that the recycle gas comprises only a small amount thereof, which can allow the hydrotreating and hydrocracking catalyst to retain a good catalytic activity.

The Applicant Company has found, surprisingly, that the process according to the invention makes it possible to improve the properties of the gas oil fraction exiting from the process for FCC pretreatment (after a stage of gas oil fraction/FCC feedstock separation), in addition in terms of sulfur content, of density (measured at 15° C.) and of cetane number. Thus, and without a subsequent hydrotreating being needed, a gas oil corresponding to the current specifications can be obtained.

Furthermore, the gas oil fraction obtained comprises a high content of biofuel, exhibiting a better cetane number and a lower density. The process according to the invention can thus make it possible to introduce biofuel into the gas oil produced, without significant modification to existing mild hydrocracking units.

Another advantage of the process is to result in a better performance of the process for the pretreatment of the FCC feedstock by virtue of the fact of diluting the conventional feedstock of the process for FCC pretreatment with a feedstock of biological origin. This better pretreatment performance affects the FCC itself, since it is thus possible to obtain products having a lower sulfur content at the outlet of the FCC.

The treatment of the biological feedstock results in particular in the production of compounds, in particular CO, which can exhibit inhibiting effects on catalysts.

Furthermore, the feedstock of petroleum origin can comprise compounds which are inhibitors of catalysts, in particular of the hydrotreating (hydrodesulfurization, hydrodenitrogenation, hydrogenation of aromatics or cracking), reactions, such as nitrogen, basic nitrogen and the aromatics of the feedstock of petrolum origin. Some compounds having a basic nature (for example basic nitrogen) are well known for reducing the cracking activity of acid catalysts, such as silicas/aluminas or zeolites.

In point of fact, in the context of the invention and with a CoMo and/or NiMo catalyst, it has been found that the effect related to the inhibiting compounds of the feedstock of petroleum origin was reduced, in particular erased, indeed even more than counterbalanced, by the dilution effect due to the biological feedstock. This is because this biological feedstock makes it possible to reduce the relative amount of inhibitor included in the petroleum feedstock.

This thus allows the process according to the invention to be carried out in “conventional” units which can be used in the treatment of feedstocks of solely petroleum origin.

The catalyst used in the process according to the inventiton can comprise or be composed of a CoMo and/or NiMo catalyst.

According to an alternative form, the feedstock treated by FCC comprises, in addition to the effluent from the mild hydrocracking having an initial boiling point of greater than 330° C., a portion of VGO and/or of DAO, in particular originating from the hydrocarbon feedstock for the mild hydrocracking.

This may make possible an improvement from the viewpoint of the industrial feasibility, for example by retaining or by increasing the amount of VGO treated (with respect to these known processes without incorporation of biological feedstock). Only the amount of feedstock treated by FCC decreases, which can be an advantage insofar as in some cases it is desirable to reduce the proportion of gasoline obtained.

Advantageously, the portion of the VGO and/or DAO is such that the feedstock intended to be conveyed to FCC (mixture of said portion and of the effluent from the mild hydrocracking having an initial boiling point of greater than 330° C.) exhibits a sulfur content of less than or equal to 2500 ppm, in particular of less than or equal to 1500 ppm, indeed even of less than or equal to 1000 ppm.

The invention also relates to a plant which can be used for the implementation of the process according to the invention, that is to say for carrying out a process for the pretreatment of an FCC feedstock.

This plant comprises, generally:

a mild hydrocracking region (7) comprising a catalyst and equipped with a pipe (5) for the introduction of hydrogen, with a pipe (6) for the introduction of the feedstock of petroleum origin, which is a vacuum distillate and/or a deasphalted oil, 85% by weight at least of which boils above 370° C., and with a pipe (13) for the introduction of a feedstock of biological origin of the vegetable oil and/or animal fat type, and with a pipe (8) for the discharge of the effluent,

a separation region (9) equipped with a pipe for the introduction of said effluent and with at least one pipe (14) for the discharge of a fraction having an initial boiling point of greater than 330° C. and with a pipe (10) for separating a fraction, the distillation range of which is between 130 and 390° C.,

a unit (not represented in the figure), situated downstream of the separation region (9), for the treatment and separation of the carbon monoxide present in the vapor phase of the effluent,

a catalytic cracking (FCC) region (15) equipped with a pipe (14) for the introduction of said fraction having an initial boiling point of greater than 330° C., with at least one pipe (16) for the departure of an LCO and with at least one pipe (17) for the departure of an HCO.

More specifically, this plant comprises, generally:

a column (2) for the atmospheric distillation of a crude oil equipped with a pipe (1) for the introduction of a crude oil, with at least one pipe for the withdrawal of a gas oil fraction and with a pipe (3) for the withdrawal of the atmospheric residue,

a vacuum distillation column (4) equipped with a pipe (3) for the introduction of said atmospheric residue and with at least one pipe (6) for the withdrawal of a vacuum distillate and with a pipe (11) for the withdrawal of the vacuum residue,

a mild hydrocracking region (7) comprising a catalyst and equipped with a pipe (5) for the introduction of hydrogen, with a pipe (6) for the introduction of the feedstock of petroleum origin, which is a vacuum distillate and/or a deasphalted oil, 85% by weight at least of which boils above 370° C. and 95% by weight at least of which boils below 650° C., and with a pipe (13) for the introduction of a feedstock of biological origin of the vegetable oil and/or animal fat type, and with a pipe (8) for the discharge of the effluent,

a separation region (9) equipped with a pipe for the introduction of said effluent and with at least one pipe (14) for the discharge of a fraction having an initial boiling point of greater than 330° C. and with a pipe (10) for separating a fraction, the distillation range of which is between 130 and 390° C.,

a unit (not represented in the figure), situated downstream of the separation region (9), for the treatment and separation of the carbon monoxide present in the vapor phase of the effluent,

a catalytic cracking (FCC) region (15) equipped with a pipe (14) for the introduction of said fraction having an initial boiling point of greater than 330° C., with at least one pipe (16) for the departure of an LCO and with at least one pipe (17) for the departure of an HCO.

According to one embodiment, the feedstock of biological origin is mixed with the feedstock of petroleum origin before it is introduced into the mild hydrocracking reactor.

The high exothermicity of the hydrotreating of the triglycerides of the biomass is then controlled by the presence of the feedstock of petroleum origin, which makes it possible to avoid modifying the pretreatment reactor, for example at levels of incorporation of less than 30%.

Furthermore, the exothermicity related to the hydrotreating of the feedstock of biological origin makes it possible to improve the heat balance of the hydrocracking unit according to the invention. This is because the exothermicity related to the hydrotreating of the feedstock of biological origin makes it possible, in addition, to reduce the inlet temperature of the pretreatment reactor while retaining an equivalent mean reaction temperature in this pretreatment reactor. Inlet temperature is understood to mean the temperature at which the fluids enter the pretreatment reactor. The mean reaction temperature is the mean temperature inside the reactor.

According to another embodiment of the invention, the feedstock of petroleum origin is injected into a first catalytic region of the mild hydrocracking unit and the feedstock of biological origin is injected into a second catalytic region of the mild hydrocracking unit situated downstream of the first catalytic region.

Thus, the hydrodeoxygenation of the feedstock of biological origin takes place downstream of the hydrodesulfurization of the petroleum fraction, so that the latter can be carried out without the inhibiting effect of the CO and of the other gases formed during the hydrodeoxygenation reaction of the triglycerides of the feedstock of biological origin and so that the hydrogen partial pressure will not be lowered by the hydrorefining reaction of the feedstock of biological origin, which makes it possible to maintain a high catalytic activity in hydrodesulfurization.

The downstream introduction of the feedstock of biological origin also makes it possible to carry out the hydrodeoxygenation of the latter under more favorable conditions (lower hydrogen partial pressure, lower temperature, and the like) which limit the formation of CH₄ and H₂O, which reduces the consumption of H₂ and the exothermicity of the reaction.

Preferably, the level of the feedstock of biological origin of the vegetable oil and/or animal fat type can range up to 30% by weight, that is to say that the feedstock of biological origin can constitute up to 30% by weight of the total feedstock composed of the feedstock of petroleum origin and of the feedstock of biological origin.

More preferably still, the level of the feedstock of biological origin of the vegetable oil and/or animal fat type is less than or equal to 15% by weight.

The feedstock of petroleum origin is advantageously chosen from vacuum distillation distillates, such as VGO (Vacuum Gas Oil), gas oils resulting from conversion processes and deasphalted residues.

The vegetable or animal oils used according to the invention are predominantly composed of fatty acid triglycerides (>90% by weight), the chain length depending on the nature of the oil used.

The vegetable oils can in particular be palm oil, soybean oil, rapeseed oil, sunflower oil, linseed oil, rice bran oil, corn oil, olive oil, castor oil, sesame oil, pine oil, peanut oil, palm kernel oil, coconut oil or babassu oil, preferably palm oil, or a mixture of two or more of these oils. These oils will essentially produce C₁₅ to C₁₈ paraffins.

A particularly advantageous way of using the invention is to preferably use soybean oil or any other vegetable oil or oil of animal origin capable of producing, by hydrotreating, a maximum of C₁₅ to C₁₈ paraffins, preferably C₁₅ or C₁₆ paraffins, so as to bring about a significant increase in the cetane number of the feedstocks produced while reducing the density as much as possible.

Use may be made, as animal fats, for example, of fish fat.

However, the incorporation of a feedstock of biological origin in the feedstock of petroleum origin results in the formation of new products (CO, CO₂, H₂O) which will be reencountered in these recycled gases, at the outlet of the separation region (9). It can then be advantageous to provide condensers, in order to remove the water, and/or a unit for the treatment and separation of the carbon monoxide produced.

Advantageously, the process according to the invention comprises a treatment of recycle gas before it is reinjected into the mild hydrocracking reactor. During this additional treatment, the carbon monoxide present in said recycle gas is treated and is separated from said recycle gas before it is reinjected into the mild hydrocracking reactor.

Such a unit for the treatment and separation of the carbon monoxide produced can be a unit for the conversion of the carbon monoxide to give carbon dioxide according to the reaction:

CO+H₂O→X CO₂+H₂

The resulting carbon dioxide can then be easily removed, for example by washing with amines, while the hydrogen produced can be recovered in order to reinject it into the reactor or to mix it with the hydrogen-rich gas mixed with the feedstock.

Such a unit for the conversion of the CO can be placed at the outlet of the gas separated by the separation region (9).

The mixture of the feedstock of petroleum origin and of the feedstock of biological origin as are described above is treated by the process for FCC pretreatment (or mild hydrocracking) well known to a person skilled in the art. The hydrogen is introduced in the gas phase into the reactor via a pipe other than that of the feedstock.

The operation is usually carried out under a pressure of 20 to 120 bar, often of 20 to 100 bar and generally of 40 to 90 bar or of 30 to 70 bar, at a temperature of between 300 and 500° C. and preferably between 350 and 450° C.

The hourly space velocity (HSV) and the hydrogen partial pressure are chosen as a function of the characteristics of the feedstock to be treated and of the conversion desired. Generally, the HSV lies within a range extending from 0.1 to 10 h⁻¹ and preferably from approximately 0.2 to approximately 5 h⁻¹. The total amount of hydrogen mixed with the feedstock (including the chemical consumption and the amount recycled) is usually from approximately 100 to approximately 5000 Nm³ of hydrogen per m³ of liquid feedstock and generally from 100 to 2000 Nm³/m³. Generally, it is at least 200 Nm³/m³ and preferably from 200 to 1500 Nm³/m³. The net conversion to give products boiling below 370° C. is generally between 5 and 50% by weight, advantageously between 10 and 45% by weight.

The effluent from the mild hydrocracking process is separated into a gas oil fraction, for which the distillation range is between 130 and 390° C., and a fraction having an initial boiling point above 330° C. treated downstream by the FCC process. In addition, during the separation, gasoline fractions are also obtained.

Generally, the fraction having an initial boiling point of above 330° C. is treated downstream by the FCC process but it could also, for example, be conveyed to the fuel oil pool in order to produce a fuel oil with a very low sulfur content.

Use may be made of a conventional hydroconversion catalyst comprising, on an amorphous support, at least one metal or metal compound having a hydrodehydrogenation function.

This catalyst can be a catalyst comprising metals from Group VIII, for example nickel and/or cobalt, generally in combination with at least one metal from Group VIb, for example molybdenum and/or tungsten. Use may be made, for example, of a catalyst comprising from 0.5 to 10% by weight of nickel (expressed as nickel oxide NiO) and from 1 to 30% by weight of molybdenum, preferably from 5 to 20% by weight of molybdenum (expressed as molybdenum oxide MoO₃) on an amorphous inorganic support. The total content of oxides of metals from Groups VI and VIII in the catalyst is generally between 5 and 40% by weight and preferably between 7 and 30% by weight. The ratio by weight (expressed on the basis of the metal oxides) of metal (metals) of Group VI to metal (metals) of Group VIII is generally from approximately 20 to approximately 1 and most often from approximately 10 to approximately 2. The support will, for example, be chosen from the group formed by alumina, silica, silicas/aluminas, magnesia, clays and mixtures of at least two of these minerals.

This support can also include other compounds, for example oxides chosen from boron oxide, zirconia, titanium oxide or phosphorus pentoxide. Use is generally made of an alumina support and preferably β- or γ-alumina.

The catalyst can also comprise a promoter element, such as phosphorus and/or boron. This element may have been introduced into the matrix or, preferably, may have been deposited on the support. Silicon can also be deposited on the support, alone or with the phosphorus and/or the boron. Preferably, the catalyst comprise silicon deposited on a support, such as alumina, optionally with phosphorus and/or boron deposited on the support, and also providing at least one metal from Group VIII (Ni, Co) and at least one metal from Group VIb (Mo, W). The concentration of said element is usually less than approximately 20% by weight (on the oxide base) and generally less than approximately 10%. The concentration of boron trioxide (B₂O₃) is usually from approximately 0 to approximately 10% by weight.

Another catalyst is a silica/alumina comprising at least one metal from Group VIII and at least one metal from Group VIb.

Another type of catalyst which can be used is a catalyst comprising at least one matrix, at least one zeolite Y and at least one hydrodehydrogenation metal.

The matrices, metals and additional elements described above can also participate in the composition of this catalyst.

Advantageous y-zeolites are described in the PCT International Patent Application WO 00/71641 and patent applications EP 0 911 077 and also U.S. Pat. No. 4,738,940 and U.S. Pat. No. 4,738,941.

Some compounds having a basic nature, such as basic nitrogen, are well known to significantly reduce the cracking activity of acid catalysts, such as silicas/aluminas or zeolites. The more pronounced the acid nature of the catalyst (silica/alumina, indeed even zeolite), the greater would be the beneficial effect on the mild hydrocracking reaction of reducing the concentration of basic compounds by dilution.

FIG. 1 describes an embodiment of the invention in which the effluent obtained after the mild hydrocracking is conveyed to FCC or, in an alternative form, is conveyed with VGO. This embodiment is given by way of example and does not exhibit any limiting nature.

The crude oil is conveyed via a pipe (1) into an atmospheric distillation column (2). An atmospheric residue is withdrawn from this distillation column via a pipe (3). This residue is conveyed to a vacuum distillation (4), the vacuum residue of which is extracted via a pipe (11) feeding a conversion process (12), for example a coker. The distillate from the vacuum distillation (4) is withdrawn via a pipe (6) and conveyed to a mild hydrocracking process (7) fed with hydrogen via a pipe (5). A feedstock of biological origin of the vegetable oil and/or animal fat type is also introduced into the pipe (6) via a pipe (13), this feedstock of biological origin representing up to 30% by weight of the total feedstock passing through the pipe (6).

The effluent (8) from the mild hydrocracking process (7) constitutes, after various separation stages represented by the block (9) targeted at separating, a gas oil fraction, the distillation range of which is between 130 and 390° C., extracted via a pipe (10), and a fraction, extracted via a pipe (14), having an initial boiling point of greater than 330° C. which can advantageously constitute the feedstock of the FCC process represented by the block (15).

The feedstock brought to the FCC process (15) can also comprise VGO (18—represented in dots) originating from the distillate from the vacuum distillation (4) transported via the pipe (6).

The catalytic cracking (FCC) region is equipped with at least one pipe (16) for the departure of a light catalytic cracking gas oil (LCO) and with at least one pipe (17) for the departure of a heavy catalytic cracking gas oil (HCO).

Furthermore, the vacuum residue is advantageously introduced, in all or in part, into a conversion region (12) via the pipe (11).

FIG. 1 is, of course, presented by way of illustration of the invention.

### EXAMPLES

### Comparative Example 1 and Examples 2 and 3 According to the Invention

Three feedstocks were treated in a mild hydrocracking pilot unit. The first is composed of a vacuum distillate (VGO). The second and the third are composed of a mixture of VGO and of vegetable oils.

The VGO feedstock was treated without incorporation of vegetable oils in example 1, which acts as a reference, and with 10% and 30% by weight of soybean oil in example 2 and example 3 respectively.

The experimental conditions are described in detail below.

Plant

The process according to the invention was tested on an isothermal fixed bed pilot unit comprising a catalyst of CoMo type, with a countercurrentwise flow of the streams of liquids and gases.

The temperature profile of reactors is constant, the reactors operating in isothermal mode.

The pilot unit does not possess recycling of the gases and the feedstock is treated in a single pass, that is to say, in the terminology of the experts, in “once through”.

The purity of the hydrogen injected into the pilot unit is 100%.

Feedstock Studied

The characteristics of the VGO feedstock and of the soybean oil are given in tables 1 and 2 respectively.

The soybean oil used is of food grade.

The soybean oil exhibits the distinguishing feature of comprising a high proportion of chains with 18 carbon atoms: the C₁₈ chains represent 87.3% by weight, with respect to the total weight of the acids present in the oil, and the C₁₆ chains represent 11.3% by weight, with respect to the total weight of the acids present in the oil. Consequently, the hydrogenation of soybean oil triglycerides should result in the formation of C₁₈ paraffin chains (and/or C₁₇ paraffin chains in the case of decarbonylation or decarboxylation) and, in a smaller proportion, C₁₆ and/or C₁₅ paraffin chains.

TABLE 1
Characteristics of the VGO feedstock

| | |
|---|---|
| Density at 15° C. | 0.929 |
| Sulfur content (% by weight) | 2.09 |
| Nitrogen content (ppm) | 1492 |
| including basic nitrogen content | 564 |
| Pour point (° C.) | −12 |
| Distillation temperature | |
| (° C. ASTM D2887) | |
| 5% | 351 |
| 30% | 421 |
| 50% | 455 |
| 95% | 559 |
| 99% | 595 |
| Hydrogen content (% by weight) | 11.97 |
| Content of polyaromatics (% by weight) | 45.3 |
| Total content of aromatics (% by weight) | 63.2 |
| Polar compounds: resins (% by weight) | 3.4 |
| Asphaltenes (ppm) | <500 |
| Ni (ppm) | 0.2 |
| V (ppm) | 0.7 |

TABLE 2
Characteristics of the soybean oil

| Density at 15° C. (calculated) | | 0.9204 |
|---|---|---|
| Acid composition (percentages by weight) | | |
| Lauric acid | 12:0 | |
| Myrisic acid | 14:0 | 0 |
| Palmitic acid | 16:0 | 0.1 |
| Palmitoleic acid | 16:1 | 4.8 |
| Margaric acid | 17:0 | 0.3 |
| | 17:1 | 0.1 |
| Stearic acid | 18:0 | 0 |
| Oleic acid | 18:1 | 1.7 |
| Linoleic acid | 18:2 | 61.3 |
| Linolenic acid | 18:3 | 20.4 |
| Arachidic acid | 20:0 | 8.9 |
| Gondoic acid | 20:1 | 0.6 |
| | | 1.2 |

| | |
|---|---|
| GPC: | |
| Free fatty acids | 0.2 |
| Triglycerides | 97.8 |
| Content of elements (ppm) | |
| Nitrogen | 6 |
| Phosphorus | <5 |
| Calcium | <2 |
| Copper | <1 |
| Iron | <1 |
| Magnesium | <1 |
| Sodium | <1 |
| Chloride | <5 |
| Organic content | |
| Carbon (% by weight) | 77.68 |
| Hydrogen (% by weight) | 11.46 |
| Oxygen (% by weight) | 11.24 |

The densities and the sulfur and nitrogen contents of the feedstocks of examples 1 to 3 are shown in table 3.

TABLE 3
Characteristics of the feedstocks of examples 1 to 3

| | | Sulfur | Nitrogen | Content of |
|---|---|---|---|---|
| | Density at | content | content | vegetable oil |
| | 15° C. | (% by weight) | (ppm) | (% by weight) |
| Example 1 | 0.929 | 2.09 | 1492 | 0 |
| Example 2 | 0.928 | 1.87 | 1340 | 10 |
| Example 3 | 0.926 | 1.45 | 1042 | 30 |

Operating Conditions

The operating conditions are given in table 4.

TABLE 4
Operating conditions

| | Mild |
|---|---|
| | hydrocracking |
| | reactor |
| H₂ partial pressure reactor | 80 |
| outlet (bar) | |
| H₂/HC (Nl/l) | 400 |
| HSV (h⁻¹) | 0.8 |
| Temperature (° C.) | 390 |

The temperature of the catalyst is chosen in order to have a degree of desulfurization (HDS) of 99.6%, defined by:

$$HDS = 100 * \frac{( {S}_{Feedstock} - {S}_{Product} )}{{S}_{Feedstock}}$$

This lies in the range 350-420° C.

Quality of the Products

The effluent exiting from the reactor is separated into a gas phase and a liquid phase at ambient temperature and pressure by a set of separators. The liquid phase is subsequently continuously stripped with nitrogen to remove the residual H₂S. The liquid phase is distilled in the laboratory into a Pi-150° C. fraction, a 150-370° C. fraction (wide gas oil fraction) and a 370° C.+fraction feeding an FCC.

The yields by weight, with respect to the feedstock, and some properties of these fractions are collated in table 5.

TABLE 5
Characteristics of the effluents of examples 1 to 3

| | | Example 1 | Example 2 | Example 3 |
|---|---|---|---|---|
| Pi-150° C. | Yield with respect to | 2.11 | 1.95 | 1.63 |
| | the feedstock | | | |
| | (% by weight) | | | |
| | Density at 15° C. | 0.751 | 0.750 | 0.749 |
| | Sulfur (ppm) | 3 | 3 | 4 |
| 150-370° C. | Yield with respect to | 26.79 | 32.31 | 43.35 |
| | the feedstock | | | |
| | (% by weight) | | | |
| | Density at 15° C. | 0.8749 | 0.8521 | 0.8239 |
| | Sulfur (ppm) | 59 | 44 | 35 |
| | Cloud point (° C.) | −5 | −4 | −2 |
| | Calculated cetane | 40 | 49 | 57 |
| | number D4737 | | | |
| | GPC (triglycerides) (% | 0 | <0.05 | <0.05 |
| | by weight) | | | |
| | Content of bio gas oil | 0 | 25.37 | 56.74 |
| | in the gas oil fraction | | | |
| | (% by weight) | | | |
| 370° C.+ | Yield with respect to | 69.19 | 62.27 | 48.60 |
| | the feedstock | | | |
| | (% by weight) | | | |
| | Density at 15° C. | 0.8919 | 0.8918 | 0.8920 |
| | Sulfur (ppm) | 111 | 115 | 118 |
| | Nitrogen (ppm) | 64 | 65 | 66 |
| | Hydrogen content | 13.43 | 13.44 | 13.42 |
| | (% by weight) | | | |

The incorporation of vegetable oil in the feedstock of a hydrocracking unit has the consequence of adding normal paraffins to the final product.

As it is known that the maximum theoretical yield of paraffins is 84% by weight (from the mass balance), it may be suggested that 98% by weight of the n-paraffins resulting from the triglycerides are reencountered in the gas oil fraction.

The amount of triglycerides measured at the outlet of the mild hydrocracking reactor in examples 2 and 3 is less than the limit of detection of the GPC method (<0.05% by weight), confirming the decomposition of the triglycerides in the reactor.

Thus, for the same temperature of the mild hydrocracking reactor, the density of the 150-370° C. effluent, at the outlet of the mild hydrocracking reactor, is significantly lower when the feedstock comprises soybean oil, which results in a gas oil at the outlet of the mild hydrocracking reactor approaching the strictest specifications.

Specifically, the incorporation of soybean oil in a VGO feedstock results in modifications to the properties of the gas oil fraction:
increase in the cetane number
decrease in the density (emphasizes the GO specifications without the need for subsequent hydrotreating)
increase in the cloud point.

The increase in the cloud point may indicate that the paraffins resulting from the soybean oil are not significantly isomerized.

Furthermore, the incorporation of vegetable oil is reflected by:
an increase in the yield of gas oil (+6% by weight for example 2 and +17% by weight for example 3, with respect to example 1).

98% by weight of the paraffins resulting from the triglycerides are reencountered in the gas oil fraction and are thus only very insignificantly cracked (the distillation range 150-370° C. corresponds to C₁₀ to C₂₂ paraffins).

It is observed that the presence in the feedstock of the process for FCC pretreatment of 10% and 30% of soybean oil (example 2 and example 3 respectively) makes it possible to obtain a gas oil (150-370° C. fraction) having a lower sulfur content which exhibits a higher cetane number than in example 1.

### Comparative Example 4 and Example 5 According to the Invention

Two feedstocks were treated in the same mild hydrocracking pilot unit. The first is composed of a vacuum distillate (VGO). The second is composed of a mixture of VGO and of vegetable oils.

The VGO feedstock was treated without incorporation of vegetable oils in example 4, which acts as reference, and with 9.5% by weight of soybean oil in example 5.

If these examples are adapted to the industrial scale, this would correspond to two configurations which result in the same amount of converted VGO (in this instance 100 t).

In example 4, 100 t of VGO are subjected to mild hydrocracking and then the resulting feedstock is separated into different fractions, the 370° C.+residue being conveyed to FCC.

In example 5, 95 t of VGO and 10 tonnes of vegetable oils are subjected to mild hydrocracking and then the resulting feedstock is separated into different fractions, the 370° C.+residue, to which 5 tonnes of VGO are added, being subsequently conveyed to FCC.

The experimental conditions, on the pilot scale, are described in detail below.

Plant—Feedstock Studied

Same as above.

The densities and the sulfur and nitrogen contents of the feedstocks of examples 4 and 5 are shown in table 6.

TABLE 6
Characteristics of the feedstocks feeding the mild hydrocracking
unit of examples 4 and 5

| | | Sulfur | Nitrogen | Content of |
|---|---|---|---|---|
| | Density at | content | content | vegetable oil |
| | 15° C. | (% by weight) | (ppm) | (% by weight) |
| Example 4 | 0.929 | 2.09 | 1492 | 0 |
| Example 5 | 0.928 | 1.89 | 1345 | 9.5 |

Operating Conditions

The operating conditions are given in table 7.

TABLE 7
Operating conditions in the mild hydrocracking reactor

| | |
|---|---|
| Example 4 | Example 5 |

| | |
|---|---|
| H₂ partial pressure reactor | 80 |
| outlet (bar) | |
| H₂/HC (Nl/l) | 400 |

| | | |
|---|---|---|
| HSV (h⁻¹) | 1.0 | 1.05 |
| Temperature (° C.) | 362 | 395 |

Quality of the Products

The effluent exiting from the reactor is separated into a gas phase and a liquid phase at ambient temperature and pressure by a set of separators. The liquid phase is subsequently continuously stripped with nitrogen to remove the residual H₂S. The liquid phase is distilled in the laboratory into a Pi-150° C. fraction, a 150-370° C. fraction (wide gas oil fraction) and a 370° C.+fraction feeding an FCC.

The yields by weight, with respect to the feedstock, and some properties of these fractions are collated in table 8.

TABLE 8
Characteristics of the effluents from the mild hydrocracking
in examples 4 and 5

| | | Example 4 | Example 5 |
|---|---|---|---|
| Pi-150° C. | Yield with respect to the | 0.20 | 2.11 |
| | feedstock | | |
| | (% by weight) | | |
| | Density at 15° C. | 0.749 | 0.750 |
| | Sulfur (ppm) | 2 | 3 |
| 150-370° C. | Yield with respect to the | 15.91 | 32.05 |
| | feedstock | | |
| | (% by weight) | | |
| | Density at 15° C. | 0.8849 | 0.8530 |
| | Sulfur (ppm) | 976 | 45 |
| | Cloud point (° C.) | −2 | −3 |
| | Calculated cetane | 39 | 48.5 |
| | number D4737 | | |
| | GPC (triglycerides) (% | 0 | <0.05 |
| | by weight) | | |
| | Content of bio gas oil in | 0 | 24.36 |
| | the gas oil fraction (% by | | |
| | weight) | | |
| 370° C.+ | Yield with respect to the | 82.61 | 62.60 |
| | feedstock | | |
| | (% by weight) | | |
| | Density at 15° C. | 0.9014 | 0.8919 |
| | Sulfur (ppm) | 1489 | 113 |
| | Nitrogen (ppm) | 554 | 63 |
| | Hydrogen content | 13.15 | 13.42 |
| | (% by weight) | | |

TABLE 9
Characteristics of the feedstock of the FCC in examples 4
and 5

| | Example 4 | Example 5 |
|---|---|---|
| Flow rate of feedstock of | 82.61 | 67.36 |
| the FCC (t/h) | | |
| Density at 15° C. | 0.9014 | 0.8945 |
| Sulfur (ppm) | 1489 | 1584 |
| Nitrogen (ppm) | 554 | 165 |
| Hydrogen content (% by | 13.15 | 13.32 |
| weight) | | |

In addition to the advantages and the conclusions expressed in the preceding examples, the present examples further show that, under the same conditions as with a conventional feedstock, the invention makes it possible:

to increase the amount of gas oil produced,

to improve the quality of the gas oil produced,

to reduce the amount of gasoline produced at the outlet of the FCC by reducing the amount of feedstock treated by the FCC,

to keep the amount of sulfur in the FCC feedstock at an acceptable level in order not to interfere with obtaining an amount of sulfur of less than 10 ppm at the FCC outlet, and

to improve other properties of the FCC feedstock (density, nitrogen content and/or hydrogen content).

What is claimed is:

1. A process, which comprises the stages consisting in:
carrying out a mild hydrocracking, implemented under a pressure of 20 to 120 bar and at a temperature of between 300 and 500° C., on a hydrocarbon feedstock comprising or consisting of:
a feedstock of petroleum origin, comprising or consisting of a vacuum distillate fraction and/or a deasphalted oil, at least 85% by weight of which boils above 370° C., and
a feedstock of biological origin comprising components of the vegetable oil and/or animal fat type,
in order to produce gas oil and an effluent having an initial boiling point of greater than 330° C. within the meaning of the simulated distillation according to standard ASTM D2887, and
carrying out a catalytic cracking (FCC) of a composition comprising or consisting of said effluent.

2. The process as claimed in claim 1, wherein the feedstock treated by FCC comprises, in addition to the effluent from the mild hydrocracking having an initial boiling point of greater than 330° C., a portion of VGO and/or of DAO, in particular originating from the hydrocarbon feedstock for the mild hydrocracking.

3. The process as claimed in claim 2, wherein the feedstock treated by FCC, comprising, in addition to the effluent, a portion of VGO and/or of DAO, exhibits a sulfur content of less than or equal to 2500 ppm, in particular of less than or equal to 1500 ppm, indeed even of less than or equal to 1000 ppm.

4. The process as claimed in any one of claims 1 to 3, wherein the feedstock of biological origin is mixed with the feedstock of petroleum origin before it is introduced into the mild hydrocracking reactor.

5. The process as claimed in any one of claims 1 to 3, wherein the feedstock of petroleum origin is injected into a first catalytic region of the mild hydrocracking unit and wherein the feedstock of biological origin is injected into a second catalytic region of the mild hydrocracking unit situated downstream of the first catalytic region.

6. The process as claimed in any one of claims 1 to 5, wherein the content of the hydrocarbon feedstock of feedstock of biological origin of the vegetable oil and/or animal fat type is less than or equal to 30% by weight, with respect to the total weight of the hydrocarbon feedstock.

7. The process as claimed in claim 6, wherein the content of feedstock of biological origin is less than or equal to 15% by weight, with respect to the total weight of the hydrocarbon feedstock.

8. The process as claimed in any one of claims 1 to 7, wherein the feedstock of petroleum origin is chosen from vacuum distillation distillates, gas oils resulting from conversion processes and/or deasphalted residues.

9. The process as claimed in any one of claims 1 to 8, wherein the vegetable oils are chosen from palm oil, soybean oil, rapeseed oil, sunflower oil, linseed oil, rice bran oil, corn oil, olive oil, castor oil, sesame oil, pine oil, peanut oil, palm kernel oil, coconut oil or babassu oil, preferably palm oil, or a mixture of at least two of these oils.

10. The process as claimed in any one of claims 1 to 9, which comprises a treatment of recycle gas before it is reinjected, in particular into the pretreatment reactor, in which an additional treatment is carried out during which the carbon monoxide present in said recycle gas is treated and is separated from said recycle gas before it is reinjected into the mild hydrocracking reactor.

11. The process as claimed in any one of claims 1 to 10, wherein the catalyst used in the mild hydrocracking comprises or is composed of CoMo and/or of NiMo.

12. A plant for carrying out a process for the pretreatment of an FCC feedstock by mild hydrocracking with a feedstock of petroleum origin which is a vacuum distillate and/or a deasphalted oil and which comprises:
a mild hydrocracking region (7) comprising a catalyst and equipped with a pipe (5) for the introduction of hydrogen, with a pipe (6) for the introduction of the feedstock of petroleum origin, which is a vacuum distillate and/or a deasphalted oil, 85% by weight at least of which boils above 370° C., and with a pipe (13) for the introduction of a feedstock of biological origin of the vegetable oil and/or animal fat type, and with a pipe (8) for the discharge of the effluent,
a separation region (9) equipped with a pipe for the introduction of said effluent and with at least one pipe (14) for the discharge of a fraction having an initial boiling point of greater than 330° C. and with a pipe (10) for separating a fraction, the distillation range of which is between 130 and 390° C.,
a catalytic cracking (FCC) region (15) equipped with a pipe (14) for the introduction of said fraction having an initial boiling point of greater than 330° C., with at least one pipe (16) for the departure of an LCO and with at least one pipe (17) for the departure of an HCO,
comprising, downstream of the separation region (9), a unit for the treatment and separation of the carbon monoxide present in the vapor phase of the effluent, for the implementation of the process as claimed in claim 10.

13. The plant as claimed in claim 12, wherein the feedstock treated by FCC comprises, in addition to the effluent, a portion of VGO and/or of DAO, in particular originating from the hydrocarbon feedstock for the mild hydrocracking.
